(19) United States
(12) Patent Application Publication
(10) Pub. No.: US 2014/0349057 A1
(43) Pub. Date: Nov. 27, 2014

(54) INSULATING MATERIAL WITH CONTINUOUS INSULATION AND FILL

(71) Applicant: Columbia Sportswear North America, Inc., Portland, OR (US)

(72) Inventors: Michael E. "Woody" Blackford, Portland, OR (US); Christopher R. Araujo, Portland, OR (US); Jeffrey T. Mergy, Portland, OR (US)

(73) Assignee: Columbia Sportswear North America, Inc., Portland, OR (US)

(21) Appl. No.: 14/286,869

(22) Filed: May 23, 2014

Related U.S. Application Data
(60) Provisional application No. 61/827,399, filed on May 24, 2013.

(51) Int. Cl. F16L 59/02; F16L 59/04

(52) U.S. Cl. CPC F16L 59/029; F16L 59/04
USPC 428/71; 156/291; 428/76; 428/74

(57) ABSTRACT

Insulating materials, methods of forming insulating materials, and products including insulating materials are disclosed herein. In some embodiments, an insulating material may include a lining material layer, a face material layer, at least one layer of continuous synthetic insulation disposed between the lining material layer and the face material layer, fill disposed between the lining material layer and the face material layer, one or more first seams coupling the lining material layer and the at least one layer of continuous synthetic insulation, and one or more second seams coupling the face material layer and the at least one layer of continuous synthetic insulation. The first and second seams may form two or more baffles partitioning the fill in the insulating material. Other embodiments may be disclosed and/or claimed.

### CROSS REFERENCE TO RELATED APPLICATIONS

The present application claims priority to U.S. Provisional Patent Application No. 61/827,399, filed May 24, 2013, entitled “Insulating Material with Continuous Insulation and Fill Layers,” the entire disclosure of which is hereby incorporated by reference in its entirety.

### BACKGROUND

Synthetic insulation sometimes provides good thermal insulation, but tends not to loft and may not trap sufficient warm body air. Non-synthetic materials, like down, may be lighter than synthetic insulation, but may exhibit degrading thermal performance when wet and may migrate within a product, resulting in an uneven distribution of insulation.

### BRIEF DESCRIPTION OF THE DRAWINGS

Embodiments will be readily understood by the following detailed description in conjunction with the accompanying drawings and the appended examples. Embodiments are illustrated by way of example and not by way of limitation in the accompanying drawings.

FIGS. 1A-1E depict insulating materials having various arrangements of layers of face material, continuous insulation, fill, and lining material, before any seams are formed, in accordance with various embodiments.

FIGS. 2A-2C depict insulating materials having various arrangements of seams and baffles, along with arrangements of layers of face material, continuous insulation, fill, and lining material, in accordance with various embodiments.

FIG. 3 depicts a garment that may include any of the insulating materials of the present disclosure, in accordance with various embodiments.

FIG. 4 is a flow diagram of a first method of forming an insulating material, in accordance with various embodiments.

FIGS. 5A-5G depict an insulating material subsequent to various manufacturing operations, in accordance with various embodiments.

FIG. 6 is a flow diagram of a second method of forming an insulating material, in accordance with various embodiments.

### DETAILED DESCRIPTION OF THE DRAWINGS

In the following detailed description, reference is made to the accompanying drawings that form a part hereof, and in which are shown by way of illustration embodiments that may be practiced. It is to be understood that other aspects and/or embodiments may be utilized and structural or logical changes may be made without departing from the scope. Therefore, the following detailed description is not to be taken in a limiting sense.

For the purposes of the description, a phrase in the form “A/B” or in the form “A and/or B” means (A), (B), or (A and B). For the purposes of the description, a phrase in the form “at least one of A, B, and C” means (A), (B), (C), (A and B), (A and C), (B and C), or (A, B, and C).

The description may use the terms “embodiment” or “embodiments,” which may each refer to one or more of the same or different embodiments. Furthermore, the terms “comprising,” “including,” “having,” and the like, as used with respect to embodiments, are synonymous, and are generally intended as “open” terms (e.g., the term “including” should be interpreted as “including but not limited to,” the term “having” should be interpreted as “having at least,” the term “includes” should be interpreted as “includes but is not limited to,” etc.).

With respect to the use of any plural and/or singular terms herein, those having skill in the art can translate from the plural to the singular and/or from the singular to the plural as is appropriate to the context and/or application. The various singular/plural permutations may be expressly set forth herein for the sake of clarity and illustration, but are not limiting.

Disclosed herein are insulating materials, methods of forming insulating materials, and products including insulating materials. In some embodiments, an insulating material may include a lining material layer, a face material layer, at least one layer of continuous synthetic insulation disposed between the lining material layer and the face material layer, at least one layer of fill disposed between the lining material layer and the face material layer, first seams coupling the lining material layer and the at least one layer of continuous synthetic insulation, and second seams coupling the face material layer and the at least one layer of continuous synthetic insulation. The first and second seams may form two or more baffles in the insulating material.

Various ones of the embodiments disclosed herein may include novel arrangements of insulating materials within a single baffle. For example, some of the embodiments disclosed herein may include both continuous insulation and fill in a single baffle. In some such embodiments, the continuous insulation may be a synthetic continuous insulation, and the fill may be down. These different materials may have properties that have been determined to be complementary in outdoor conditions, and combining them in accordance with the arrangements disclosed herein may enable the advantageous properties of each to be utilized. For example, when down gets wet, it may lose some of its insulative performance and its loft may decrease; if a synthetic material is also included in a baffle, the synthetic material may still provide sufficient insulation if the baffle becomes wet and the down is “compromised.”

Some of the embodiments disclosed herein may reduce the occurrence of “cold spots” in an insulating material. Such cold spots may occur at conventional stitch lines, where a face material is secured to a lining material to form the boundary of a baffle. Conventional stitch lines lack any insulation, and thus act as conduits for heat to escape or for cold air to penetrate. As discussed below, various ones of the embodiments disclosed herein may include an insulating material between the face material and the lining material at a stitch line, reducing heat loss through the stitch line. Various ones of the embodiments disclosed herein may not couple the face material to the lining material and a single stitch line, but may instead couple the face material to a continuous insulation layer at a first location and couple the lining material to the continuous insulation layer and a second location spaced away from the first location. This construction may help reduce or eliminate stitch lines “through” the insulating material, reducing or eliminating the cold spots associated with conventional stitch lines.

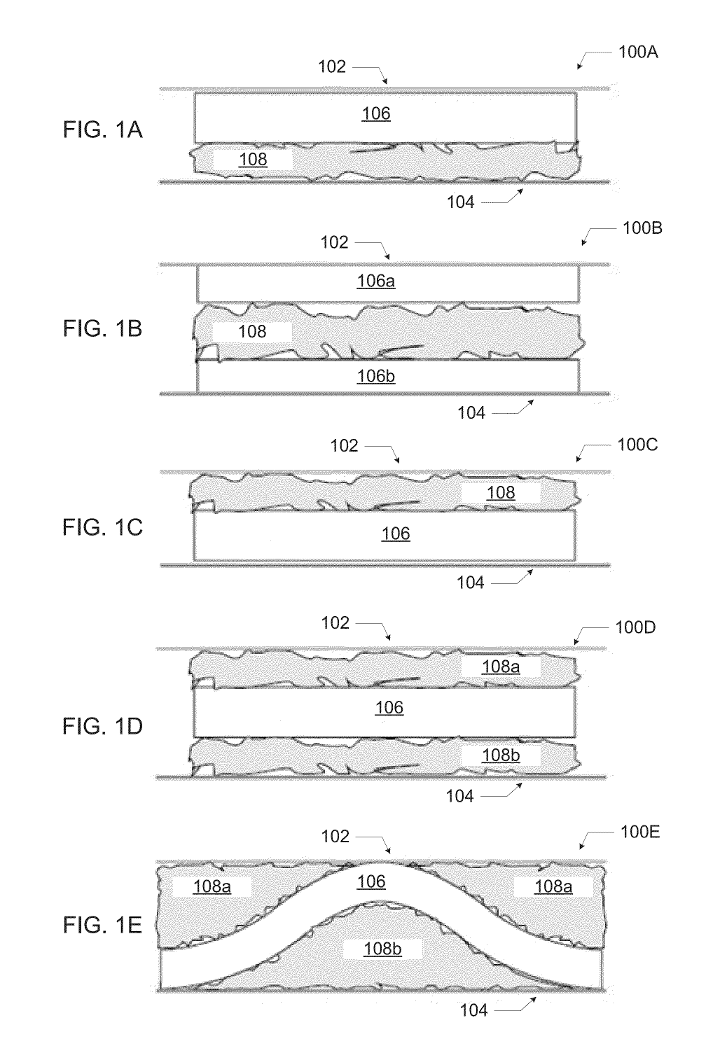

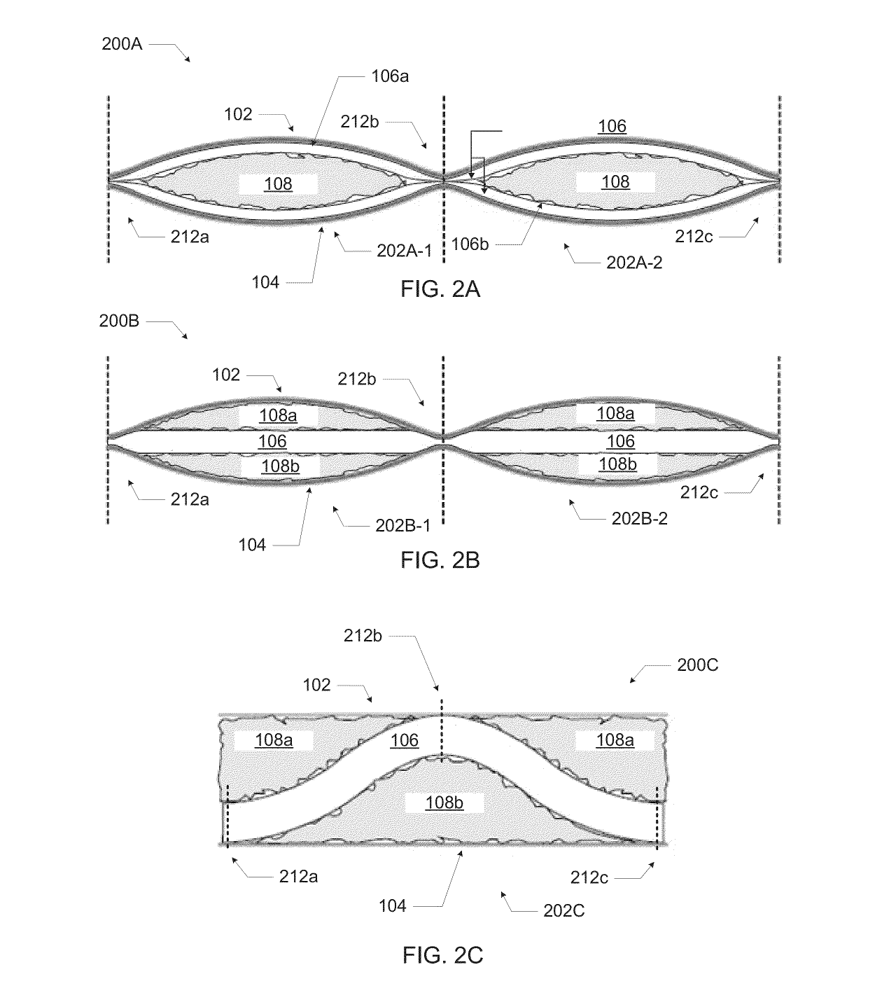

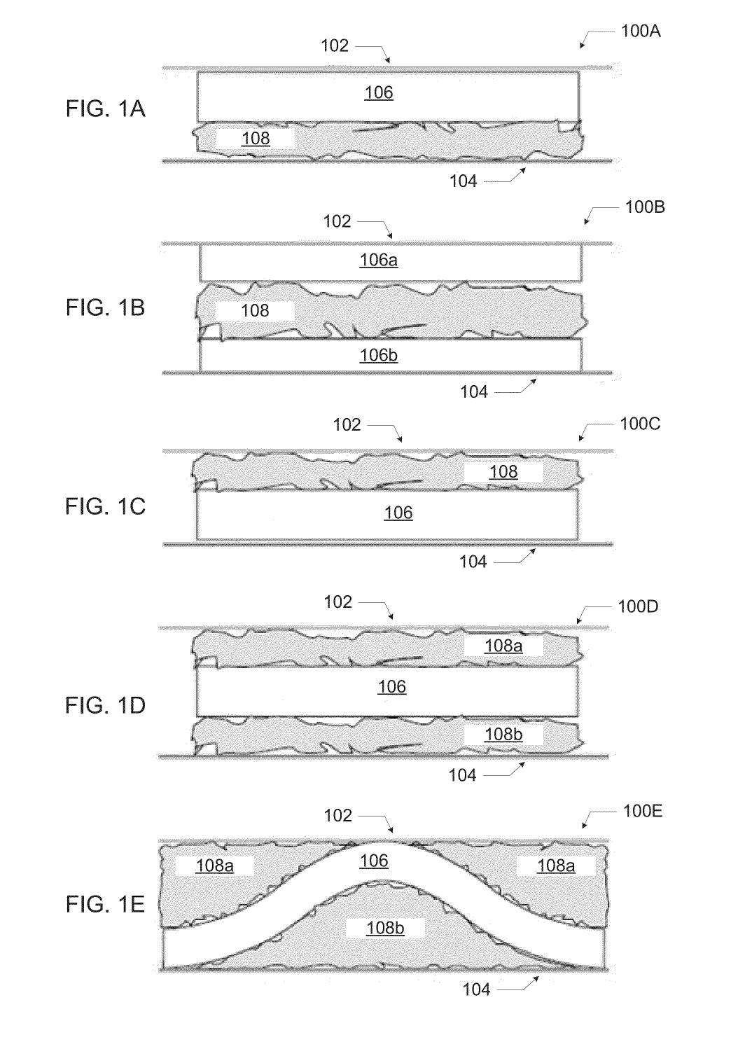

FIGS. 1A-1E depict insulating materials having various arrangements of layers of face material, continuous insulation, fill, and lining material, before any seams are formed, in accordance with various embodiments. The insulating materials shown in FIGS. 1A-1E are simply illustrative, and additional insulating materials within the present disclosure include stacks of one or more of the depicted insulating materials, side-by-side combinations of one or more of the depicted insulating materials, overlapping combinations of one or more of the depicted insulating materials, or any other combination of the depicted insulating material. For example, a first portion of an insulating material may include a first number of layers of continuous insulation and a second portion of the insulating material may include a second, different number of layers of continuous insulation. Any of the materials disclosed herein for the face material layer, the lining material layer, the continuous insulation layer, and the fill for any particular embodiment may be used in any combination in any other embodiment of the insulating material. As used herein, the term “continuous insulation” refers to insulation that is provided in roll or sheet form. In some embodiments, continuous insulation may be formed of a synthetic material. Various particular embodiments in which continuous insulation is a synthetic continuous insulation are discussed herein. In some embodiments, continuous insulation may not necessarily be formed of a synthetic material, and may be formed of a fabric, knit, wool, fleece, or other desired material.

As shown in FIG. 1A, an insulating material 100A may include a face material layer 102 disposed next to a continuous insulation layer 106, disposed next to fill 108, disposed next to a lining material layer 104. In some embodiments, the fill 108 may include down plumes or feathers, aerogel, wool, flannel, or any other insulating fill. In general, thicker and loftier insulating materials may be “warmer,” but the proper choice of material may depend on the intended use of the insulating material (e.g., for extreme cold weather conditions or for milder conditions). In some embodiments, a lightweight construction may be desired.

In some embodiments, the continuous insulation layer 106 may include one or more of various insulating materials such as wool, aerogel, synthetic insulations, and OMNI-HEAT® reflective fabrics. In some embodiments, the continuous insulation layer 106 may include one or more synthetic materials. In some embodiments, the face material layer 102 and the lining material layer 104 may include one or more of the materials typically used in garments such as nylon, polyester, polypropylene, waterproof breathable materials, wovens, knits, and non-woven garment materials, among others.

Various ones of the embodiments disclosed herein may have different arrangements of the fill 108 and the continuous insulation layer 106 relative to the face material layer 102 in a lining material layer 104. In garments in which the lining material layer 104 is disposed next to the wearer's skin, having a synthetic continuous insulation layer 106 close to the lining material layer 104 may provide improved moisture management. In particular, synthetic continuous insulation may absorb and process moisture in an improved manner relative to down fill, for example. Thus, having a synthetic continuous insulation layer 106 closer to the lining material layer 104 than a down fill 108 may be beneficial in some applications. Having the fill 108 close to the face material layer 102 may provide a “puffier” look to the garment, which may be desirable to some wearers. In other garments in which the lining material layer 104 is disposed next to the wearer's skin, having a down fill 108 closer to the lining material layer 104 may be softer and more comfortable for the wearer.

As shown in FIG. 1B, an insulating material 100B may include a face material layer 102 disposed next to a continuous insulation layer 106a, disposed next to fill 108, disposed next to another continuous insulation layer 106b, disposed next a lining material layer 104. The two continuous insulation layers 106a, 106b may be formed from the same material or from different materials.

As shown in FIG. 1C, an insulating material 100C may include a face material layer 102 disposed next to fill 108, disposed next to a continuous insulation layer 106, disposed next to a lining material layer 104. As noted above, in garments in which the lining material layer 104 is disposed next to the wearer's skin, having a synthetic continuous insulation layer 106 close to the lining material layer 104 may provide improved moisture management. Having the fill 108 close to the face material layer 102 may provide a “puffier” look to the garment, which may be desirable to some wearers.

As shown in FIG. 1D, an insulating material 100D may include a face material layer 102 disposed next to fill 108a, disposed next to a continuous insulation layer 106, disposed next to an additional fill 108b, disposed next to a lining material layer 104. The two fills 108a and 108b may be formed from the same material or from different materials.

As shown in FIG. 1E, an insulating material 100E may include a continuous insulation layer 106 arranged to undulate between a lining material layer 104 and a face material layer 102, with fill 108a disposed between the continuous insulation layer 106 and the lining material layer 104, and fill 108b disposed between the continuous insulation layer 106 and the face material layer 102.

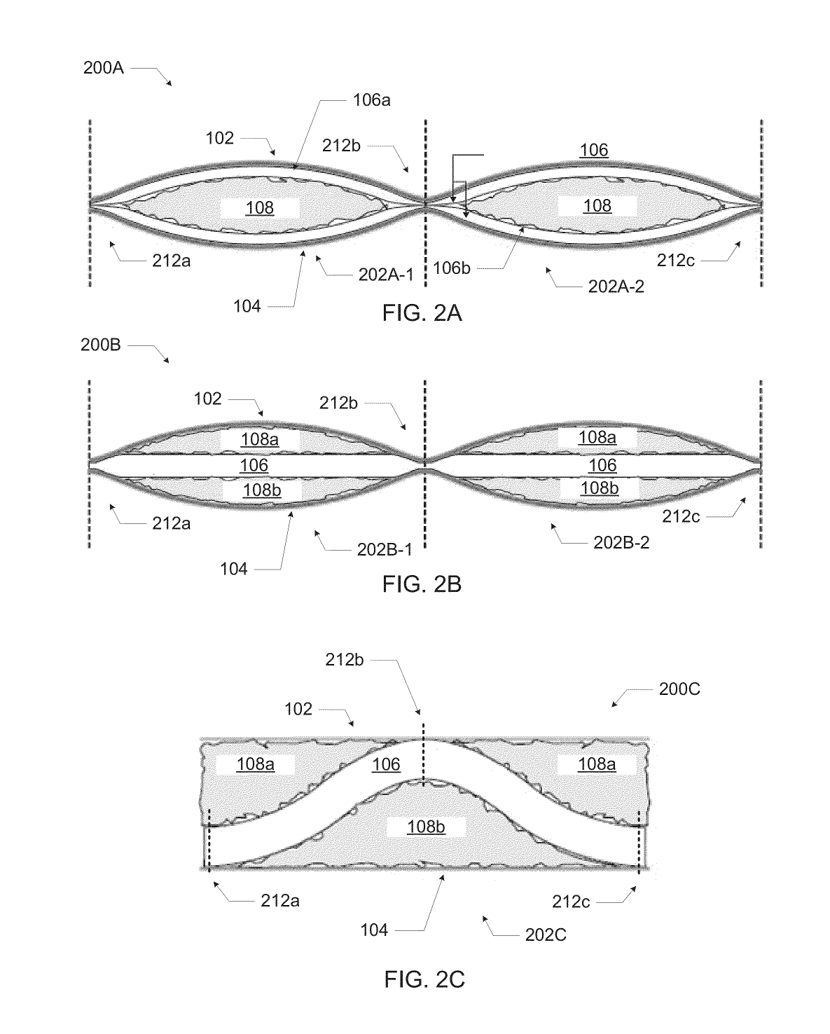

FIGS. 2A-2C depict insulating materials having various arrangements of seams and baffles, along with arrangements of layers of face material, continuous insulation, fill, and lining material, in accordance with various embodiments. As used herein, a “baffle” may refer to a portion of an insulating material that may serve as a compartment for air, separate from other such compartments. Each of FIGS. 2A-2C depict portions of insulating materials including two baffles for clarity of illustration; insulating materials with more than two baffles are contemplated herein, and may be formed by simple extension of the techniques disclosed herein.

As shown in FIG. 2A, an insulating material 200A may include seams 212a, 212b, and 212c that couple the face material layer 102 and two or more continuous insulation layers 106. The seams 212a, 212b, and 212c of FIG. 2A also couple to the lining material layer 104. In some embodiments, a seam coupling the face material layer 102 and a seam coupling the lining material layer 104 may be the same seam, as illustrated by the seams 212a, 212b, and 212c in FIG. 2A. In various embodiments, one or more seams included in an insulating material may be a stitched seam, a glued seam, or a welded seam, for example. For example, a seam may be formed by providing an adhesive tape to a first material, and bringing a second material in contact with the adhesive tape to form a seam between the first and second materials. Such a seam may be heat treated to activate or strengthen the bond between the first and second materials. The three seams illustrated in FIG. 2A together form two baffles 202A-1 and 202A-2, each including two layers of continuous insulation 106 and fill 108. The insulating material 200A of FIG. 2A may be fabricated by forming seams (and, consequently, baffles) in the insulating material 100B of FIG. 1B, for example.

As shown in FIG. 2B, an insulating material 200B may include seams 212a, 212b, and 212c that may couple the face material layer 102 and a single continuous insulation layer 106. The seams 212a, 212b, and 212c of FIG. 2B may also couple to the lining material layer 104. In some embodiments, the seams coupling the face material layer 102 and the seams coupling the lining material layer 104 may be the same seam, as illustrated by the seams 212a, 212b, and 212c in FIG. 2B. The insulating material 200B of FIG. 2B may be fabricated by forming seams in the insulating material 100D of FIG. 1D, for example. The three seams illustrated in FIG. 2B together form two baffles 202B-1 and 202B-2.

In some embodiments, some seams may couple a face material layer and a continuous insulation layer but not couple a lining material layer, while other seams may couple a lining material layer and a continuous insulation layer but not couple a face material layer. For example, as shown in FIG. 2C, an insulating material 200C may include one or more layers of continuous insulation 106 that is alternatingly secured by different seams 212a, 212b, and 212c to the lining material layer 104 and the face material layer 102. In particular, the seams 212a and 212c may couple the lining material layer 104 and the continuous insulating layer 106 but not couple the face material layer 102. The seam 212b may couple the face material layer 102 and the continuous insulation layer 106 but not couple the lining material layer 104. Fill may be alternatingly disposed between the continuous insulation layer 106 and the lining material layer 104 (e.g., as illustrated for the fill 108b in FIG. 2C), and between the continuous insulation layer 106 and the face material layer 102 (e.g., as illustrated for the fill 108a in FIG. 2C). The arrangement of FIG. 2C may be fabricated by forming seams in the arrangement of FIG. 1E, for example. The seams illustrated in FIG. 2C may form a baffle 202C.

In embodiments in which seams couple a lining material layer or a face material layer with one or more continuous insulation layers (e.g., as shown in FIGS. 2A-2C), the problem of “stitch line cold spots” (in which insulating material migrates away from seams) may be avoided. The effect of stitch line cold spots may depend on the type of seam formed, with bonded seams potentially losing less heat than sewn seams. As noted above, providing a “pad” of insulation at a stitch line may reduce the cold spot effect. Further, FIG. 2C illustrates an embodiment in which fill is disposed next to a seam coupling a continuous insulation layer with either a lining material layer or a face material layer (between the continuous insulation and either the lining material layer or the face material layer in line with the seam). In particular, FIG. 2C illustrates the fill 108a disposed next to the seams 212a and 212c, coupling the continuous insulation layer 106 with the lining material layer 104, and the fill 108b disposed next to the seam 212b, coupling the continuous insulation layer 106 with the face material layer 102. This embodiment places additional insulation (the fill) at the potential stitch/seam cold spot, and avoids compression of the fill in that location since the seam is not coupled to the fill.

In embodiments that include both fill and a continuous insulation layer in each baffle, the continuous insulation layer may help to stabilize the positioning of the fill, further reducing fill migration. A synthetic continuous insulation layer may also provide insulation if the fill, such as down, is compromised by water.

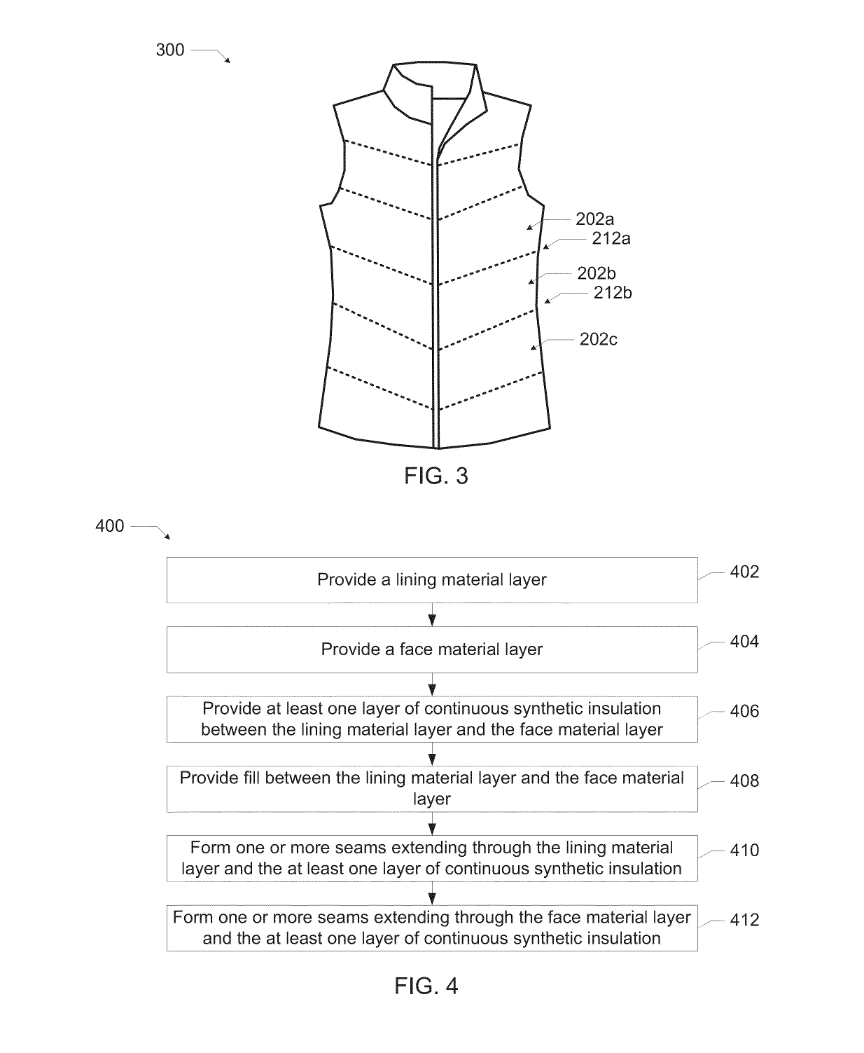

FIG. 3 depicts a garment 300 that may include any of the insulating materials of the present disclosure, in accordance with various embodiments. For example, the garment 300 may include multiple baffles 202a, 202b, and 202c defined at least in part by seams 212a and 212b, in accordance with any of the embodiments discussed herein. The insulating materials disclosed herein may be included in any of a number of products, such as apparel (such as jackets, pants, gloves, hats), footwear (such as shoes and boots), or equipment (such as sleeping bags, blankets, tents), or any other insulating product. In some embodiments, particular arrangements of fill and continuous insulation may be selected for different thermal performance in different portions of a product. For example, additional fill and/or continuous insulation layers may be included in a portion of the garment where more warmth is desired. A garment (such as the garment 300) may also include baffles or other portions that only include fill or only include continuous insulation.

FIG. 4 is a flow diagram 400 of a method of forming an insulating material, in accordance with various embodiments. The operations of the method of FIG. 4 (and any of the other methods disclosed herein) may be performed in any suitable order, and any one or more operations may be repeated or omitted as appropriate to form a particular insulating material. At 402, a lining material layer may be provided. At 404, a face material layer may be provided. At 406, at least one layer of continuous synthetic insulation may be provided. The at least one layer of continuous synthetic insulation may be disposed between the lining material layer and the face material layer. At 408, fill may be provided. The fill may be disposed between the lining material layer and the face material layer. In some embodiments, the fill may be blown into the desired locations at operation 408. At 410, one or more first seams may be formed. The first seams may couple the lining material layer and the at least one layer of continuous synthetic insulation. At 412, one or more second seams may be formed. The second seams may couple the face material layer and the at least one layer of continuous synthetic insulation. The first and second seams may form two or more baffles partitioning the fill in the insulating material. In some embodiments, 410 and 412 may be performed together (e.g., when a single seam serves as both the first seam and second seam, as illustrated in the example of the seams 212a, 212b, and 212c of FIGS. 2A and 2B).

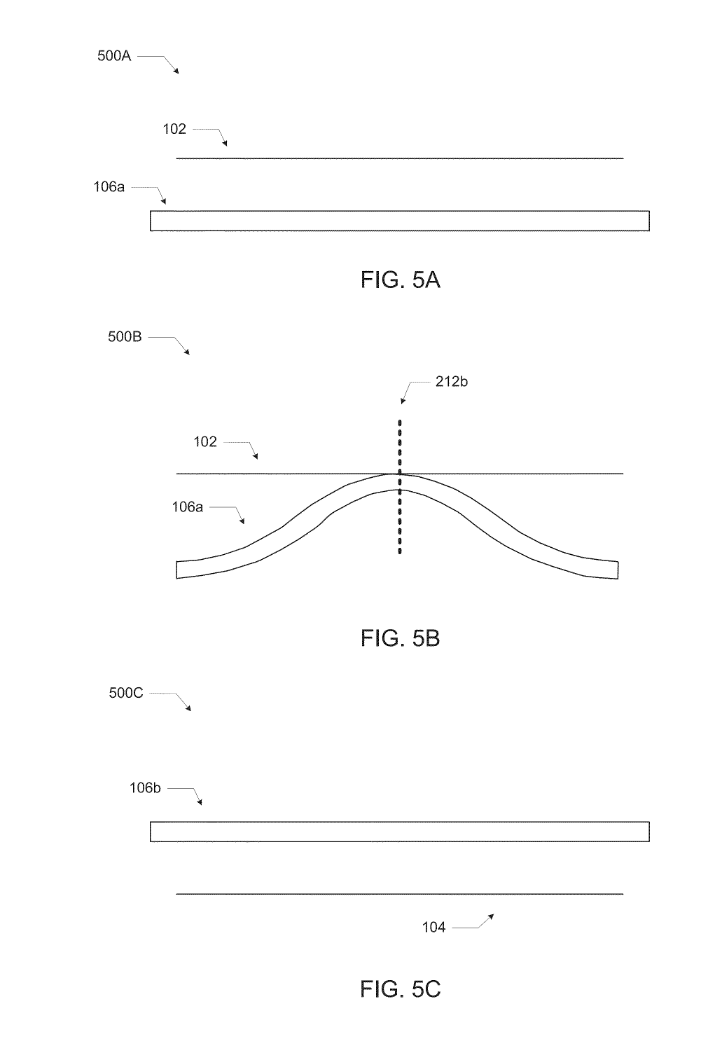

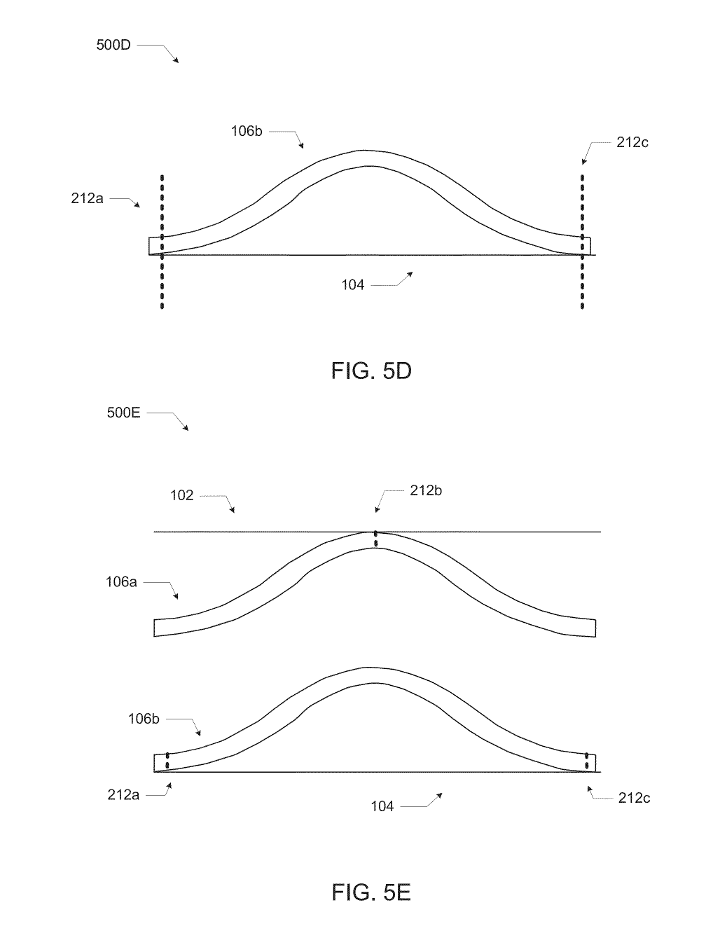

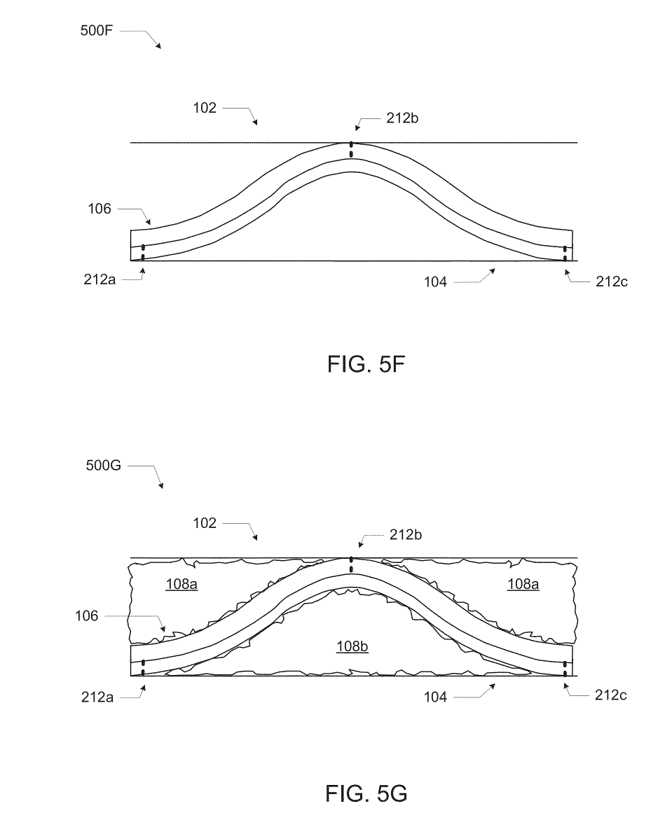

FIGS. 5A-5G depict an insulating material subsequent to various manufacturing operations, in accordance with various embodiments. As noted above with reference to FIG. 4, the manufacturing operations discussed with reference to FIGS. 5A-5G may be performed in any suitable order, and any one or more operations may be repeated or omitted as appropriate to form a particular insulating material.

FIG. 5A depicts an assembly 500A subsequent to providing a face material layer 102 and a continuous insulation layer 106a. The face material layer 102 may take the form of any of the face material layers disclosed herein. The continuous insulation layer 106a may take the form of any of the continuous insulation layers disclosed herein. In some embodiments, the continuous insulation layer 106a may include a synthetic insulation material.

FIG. 5B depicts an assembly 500B subsequent to forming a seam 212b coupling the face material layer 102 to the continuous insulation layer 106a. Although only a single seam 212b is shown in FIG. 5B, multiple seams may be formed to couple the face material layer 102 to the continuous insulation layer 106a at various intervals along the face material layer 102. In some embodiments, the continuous insulation layer 106a may “undulate” between the seams coupling the continuous insulation layer 106a to the face material layer 102 (e.g., as discussed below with reference to the assembly 500D of FIG. 5D). This construction may form baffles between the continuous insulation layer 106a and the face material layer 102.

FIG. 5C depicts an assembly 500C subsequent to providing a lining material layer 104 and the continuous insulation layer 106b. The lining material layer 104 may take the form of any of the lining material layers disclosed herein. The continuous insulation layer 106b may take the form of any of the continuous insulation layers disclosed herein. In some embodiments, the continuous insulation layer 106b may include a synthetic insulation material. In some embodiments, the continuous insulation layer 106b may be formed from a same material as the continuous insulation layer 106a. In some embodiments, the continuous insulation layer 106b may be formed from a different material as the continuous insulation layer 106a.

FIG. 5D depicts an assembly 500D subsequent to forming seams 212a and 212c coupling the lining material layer 104 to the continuous insulation layer 106b. Although only two seams 212a and 212c are shown in FIG. 5D, three or more seams may be formed to couple the lining material layer 104 to the continuous insulation layer 106b at various intervals along the lining material layer 104. In some embodiments, as shown in FIG. 5D, the continuous insulation layer 106b may “undulate” between the seams coupling the continuous insulation layer 106b to the lining material layer 104. This construction may form baffles between the continuous insulation layer 106b and the lining material layer 104. In some embodiments, the seams coupling the continuous insulation layer 106b to the lining material layer 104 may be spaced at intervals that are the same intervals that separate seams coupling the continuous insulation layer 106a to the face material layer 102. The seams coupling the continuous insulation layer 106b to the lining material layer 104 may be “offset” from the seams coupling the continuous insulation layer 106a to the face material layer 102. As a result, the undulations of the continuous insulation layer 106b, when coupled to the lining material layer 104, may be complementary to the undulations of the continuous insulation layer 106a, when coupled to the face material layer 102.

FIG. 5E depicts an assembly 500E subsequent to aligning the assembly 500B and the assembly 500D so that the undulations of the continuous insulation layer 106a are complementary to the undulations of the continuous insulation layer 106b.

FIG. 5F depicts an assembly 500F subsequent to coupling the continuous insulation layer 106a and the continuous insulation layer 106b of the assembly 500E. In some embodiments, the surface of the continuous insulation layer 106a that faces the continuous insulation layer 106b may be partially or fully coated in an adhesive such that the continuous insulation layer 106a and the continuous insulation layer 106b may be coupled when the continuous insulation layer 106a and the continuous insulation layer 106b come into contact and/or subsequent to a heat treatment to enable or improve adhesion. For example, in some embodiments, the surface of the continuous insulation layer 106a that faces the continuous insulation layer 106b may be coded in stripes of an adhesive. In some embodiments, the surface of the continuous insulation layer 106b that faces the continuous insulation layer 106a may be partially or fully coated in an adhesive, instead of or in addition to the surface of the continuous insulation layer 106a. When coupled, the continuous insulation layer 106a and the continuous insulation layer 106b may form a continuous insulation layer 106.

FIG. 5G depicts an assembly 500G subsequent to providing a fill to the assembly 500F. Three portions of fill are depicted: two portions 108a disposed between the continuous insulation layer 106 and the face material layer 102 and a portion 108b disposed between the continuous insulation layer 106 and the lining material layer 104. The assembly 500G may have the form of the insulating material 100E of FIG. 1E.

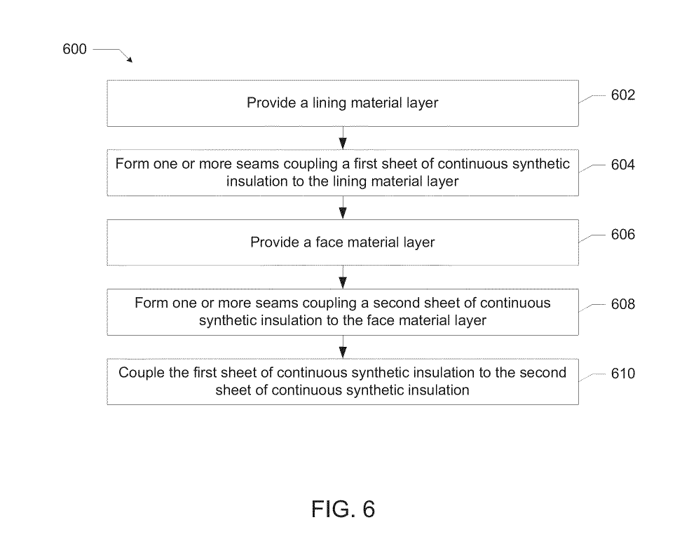

FIG. 6 is a flow diagram of a method 600 of forming an insulating material, in accordance with various embodiments. The method 600 may be used to form the insulating material 100E of FIG. 1E (e.g., in accordance with the operations described above with reference to FIGS. 5A-5G).

At 602, a lining material layer may be provided. At 604, one or more seams may be formed, coupling a first sheet of continuous synthetic insulation to the lining material layer of 602. At 606, a face material layer may be provided. At 608, one or more seams may be formed, coupling a second sheet of continuous synthetic insulation to the face material layer of 606. In some embodiments, the first and second sheets of continuous synthetic insulation may be different sheets of continuous synthetic insulation. In some embodiments, the first and second sheets of continuous synthetic insulation may be formed from different materials. At 610, the first sheet of continuous synthetic insulation may be coupled to the second sheet of continuous synthetic insulation to form an insulating material. In some embodiments, the coupling of 610 may be achieved by using an adhesive to couple the first sheet of continuous synthetic insulation to the second sheet of continuous synthetic insulation (e.g., a heat-set adhesive).

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope. Those with skill in the art will readily appreciate that embodiments may be implemented in a very wide variety of ways. This application is intended to cover any adaptations or variations of the embodiments discussed herein.

What is claimed is:

1. An insulating material comprising:
a lining material layer;
a face material layer;
at least one layer of continuous synthetic insulation disposed between the lining material layer and the face material layer;
fill disposed between the lining material layer and the face material layer;
one or more first seams coupling the lining material layer and the at least one layer of continuous synthetic insulation; and
one or more second seams coupling the face material layer and the at least one layer of continuous synthetic insulation;
wherein the first and second seams form two or more baffles partitioning the fill in the insulating material.

2. The insulating material of claim 1, wherein the fill comprises down plumes or feathers.

3. The insulating material of claim 1, wherein the fill comprises aerogel.

4. The insulating material of claim 1, wherein the fill comprises wool.

5. The insulating material of claim 1, wherein the fill comprises flannel.

6. The insulating material of claim 1, wherein the fill comprises two layers of fill, and wherein the at least one layer of continuous synthetic insulation is disposed between the two layers of fill.

7. The insulating material of claim 1, wherein the at least one layer of continuous synthetic insulation comprises two layers of continuous synthetic insulation, and wherein the fill is disposed between the two layers of continuous synthetic insulation.

8. The insulating material of claim 1, wherein the one or more first seams are the same seam as the second seams.

9. The insulating material of claim 8, wherein at least one first seam extends through the lining material layer, the face material layer, the at least one layer of continuous synthetic insulation, and the fill.

10. The insulating material of claim 1, wherein the at least one layer of continuous synthetic insulation is arranged to undulate between the lining material layer and the face material layer.

11. The insulating material of claim 10, wherein the at least one layer of continuous synthetic insulation is alternatingly secured to the lining material layer and the face material layer by a first seam and a second seam, respectively.

12. The insulating material of claim 1, wherein at least one seam of the first and second seams comprise a stitched seam.

13. The insulating material of claim 1, wherein at least one seam of the first and second seams comprise a glued seam.

14. The insulating material of claim 1, wherein at least one seam of the first and second seams comprise a welded seam.

15. The insulating material of claim 1, wherein a first portion of the insulating material comprises a first number of layers of continuous synthetic insulation and a second portion of the insulating material comprises a second number of layers of continuous synthetic insulation, the second number different from the first number.

16. The insulating material of claim 1, wherein the insulating material is included in apparel, footwear, or equipment.

17. The insulating material of claim 1, wherein the at least one layer of continuous synthetic insulation comprises two or more layers of continuous synthetic insulation coupled face to face with an adhesive.

18. The insulating material of claim 17, wherein a first layer of the two or more layers of continuous synthetic insulation is stitched to the lining material layer but not stitched to the face material layer and a second layer of the two or more layers of continuous synthetic insulation is stitched to the face material layer but not stitched to the lining material layer.

19. A method of forming an insulating material comprising:
providing a lining material layer;
providing a face material layer;
providing at least one layer of continuous synthetic insulation, the at least one layer of continuous synthetic insulation disposed between the lining material layer and the face material layer;
providing fill such that the fill is disposed between the lining material layer and the face material layer;
forming one or more first seams coupling the lining material layer and the at least one layer of continuous synthetic insulation; and
forming one or more second seams coupling the face material layer and the at least one layer of continuous synthetic insulation;
wherein the first and second seams form two or more baffles partitioning the fill in the insulating material.
